(19) United States
(12) Patent Application Publication
(10) Pub. No.: US 2015/0348120 A1
(43) Pub. Date: Dec. 3, 2015

(54) METHODS AND SYSTEMS FOR DYNAMIC PRICING

(71) Applicant: Mark Delun Yuan, San Mateo, CA (US)

(72) Inventor: Mark Delun Yuan, San Mateo, CA (US)

(21) Appl. No.: 14/290,717

(22) Filed: May 29, 2014

(51) Int. Cl. G06Q 30/02

(52) U.S. Cl. CPC G06Q 30/0269; G06Q 30/0255

(57) ABSTRACT

Systems and methods are presented for conducting consumer transactions using dynamic pricing. In some embodiments, a computer-implemented method is presented. The method may include accessing, at a mobile device of a user, at least one spending constraint of the user, with the spending constraint representing a spending limit to purchase one or more items. The method may also include transmitting the at least one spending constraint to a receiver of a merchant and accessing a modified offer to purchase one or more items from the merchant, with the modified offer for the one or more items being modified from an original offer for the one or more items based on the at least one spending constraint transmitted to the merchant.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, eBay Inc. All Rights Reserved.

### TECHNICAL FIELD

The subject matter disclosed herein generally relates to consumer transactions. In some example embodiments, the present disclosures relate to systems and methods for dynamic pricing.

### BRIEF DESCRIPTION OF THE DRAWINGS

Some embodiments are illustrated by way of example and not limitation in the figures of the accompanying drawings.

FIG. 1 is a mobile device suitable for accessing a user's spending constraints or preferences and for transmitting the spending constraints or preferences to a system of a merchant, according to some example embodiments.

FIG. 2 is a network architecture suitable fir accessing a user's spending constraints or preferences and for generating a modified offer of one or more items in a merchant's inventory based on the spending constraints or preferences, according to some example embodiments.

FIG. 3 is an illustration of an example mall environment, suitable for employing aspects of the present disclosure.

FIG. 4 is an example user prompt for inputting spending constraints on a mobile device, according to some example embodiments.

FIG. 5 illustrates various example offers based on received spending constraints, according to some example embodiments.

FIG. 6 illustrates another example environment for utilizing aspects of the present disclosure.

FIG. 7 is a flowchart illustrating example operations by a user's mobile device for conducting consumer transactions based on dynamic pricing, according to some example embodiments.

FIG. 8 is a flowchart illustrating example operations by a system of a merchant for conducting consumer transactions based on dynamic pricing, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems are presented for facilitating consumer transactions using dynamic pricing. In the information age, it would be beneficial to utilize wireless and other digital communications to facilitate more efficient consumer transactions. For example, if a potential customer has spending or other preferential constraints, it currently takes considerable effort for the potential customer to find the right sale of a desired product within those constraints. The potential customer may have his or her constraints known personally, but may not be able to easily express those constraints to merchants. Thus, the potential customer may have to browse through many shopping listings, ads, sales racks, sales bins, and so forth, just to find the right product, without the benefit of the merchant knowing what constraints the potential customer has. At other times, the potential customer may be able to talk to a sales representative to express those constraints, but this method can be slow and inefficient. On the other hand, a merchant has an incentive to try to find the right product within the constraints of the potential customer, or else the merchant may not be able to conduct a sale with that potential customer. However, current methods for communicating a potential customer's constraints can be slow, cumbersome, and cost inefficient. It may be desirable to improve on methods for conducting consumer transactions based on a potential customer's preferences or constraints.

Aspects of the present disclosure discuss methods and systems for facilitating consumer transactions using dynamic pricing. In some example embodiments, a potential customer may specify, via a mobile device for example, a spending constraint for one or more products. The spending constraint may be transmitted to one or more retailers or service providers, and in response, the one or more retailers or service providers may adjust price listings of certain products or services and/or focus on sales of products or services within the spending constraint, in an effort to satisfy the potential customer's spending constraint or preference. In some example embodiments, other constraints or preferences may also be specified by the potential customer and transmitted to one or more retailers. In some example embodiments, the retailer may adjust the sale of one or more products in different ways, based on the received constraint(s) from the potential customer. In this way, more information can be communicated between parties, thus enabling more efficient consumer transactions. In addition, the added communications can also facilitate haggling and other functions to increase the likelihood of a sale. These and other examples will be described in more detail according to the figures, below.

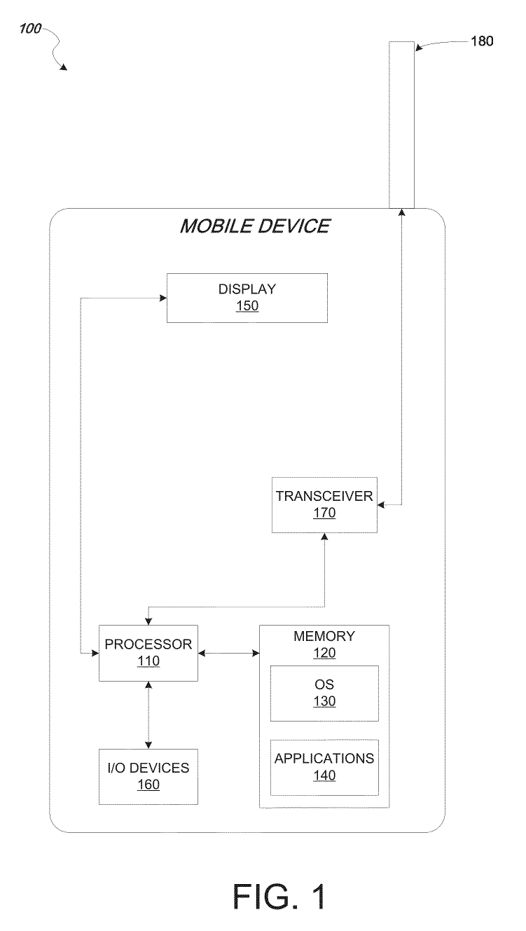

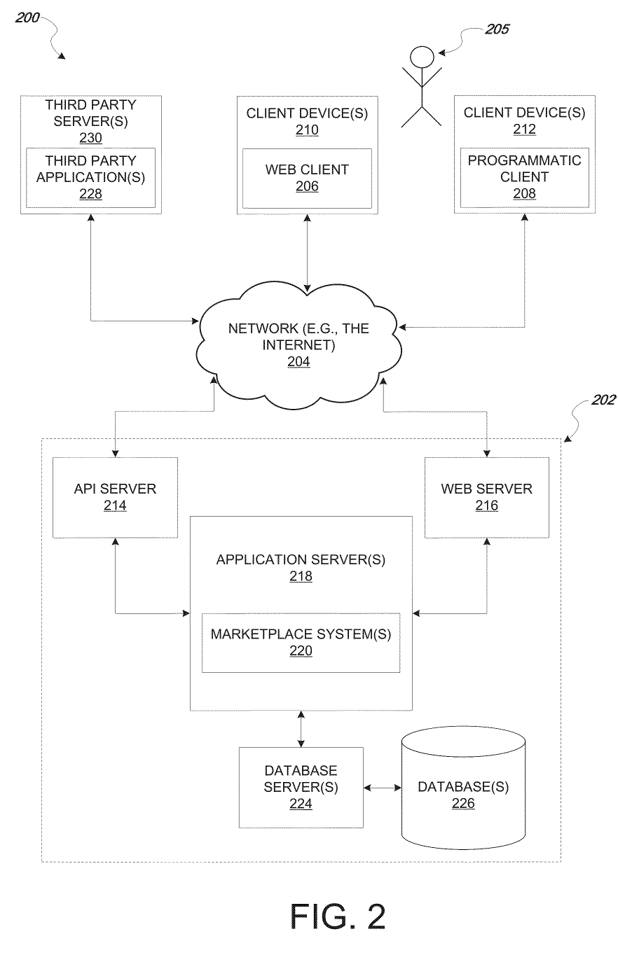

Referring to FIG. 1, a block diagram illustrating a mobile device 100 is presented, according to some example embodiments. The mobile device 100 may be configured to access user spending constraints or preferences and transmit those constraints or preferences to retailers nearby. The user spending constraints or preferences may include, for example, a maximum amount a user is willing to spend on any particular item or total amount of items, types of items for which the user is shopping, and specific preferences about any items being shopped for by the user. The mobile device 100 may be configured to display these constraints or preferences and/or prompt the user for these inputs on display 150, for example, in a user interface (UI) generated from an application running on mobile device 100. The mobile device 100 may include a processor 110. The processor 110 may be any of a variety of different types of commercially available processors suitable for mobile devices (e.g., an XScale architecture microprocessor, a Microprocessor without Interlocked Pipeline Stages (MIPS) architecture processor, or another type of processor). The processor 110 may be configured to run the application displayed in display 150, as well as facilitate transmission of the user's constraints or preferences via transceiver 170. A memory 120, such as a random access memory (RAM), a Flash memory, or other type of memory, is typically accessible to the processor 110. The memory 120 may be adapted to store an operating system (OS) 130, as well as application programs 140, such as a mobile application for accepting inputs for spending constraints or preferences that can be transmitted to nearby retailers. The processor 110 may be coupled, either directly or via appropriate intermediary hardware, to a display 150 and to one or more input/output (PO) devices 160, such as a keypad, a touch panel sensor, a microphone, and the like. Similarly, in some embodiments, the processor 110 may be coupled to a transceiver 179 that interfaces with an antenna 180. The transceiver 170 may be configured to both transmit and receive cellular network signals, wireless data signals, or other types of signals via the antenna 180, depending on the nature of the mobile device 100. Additionally, transceiver 179 may transmit the user's constraints or preferences to devices of retailers capable of receiving the constraints or preferences. In this manner, a connection with a network such as network 204 of FIG. 2, discussed more below, may be established.

Referring to FIG. 2, a high-level client-server-based network architecture 200 is shown, according to some example embodiments. The network architecture 200 may include systems, applications, modules, and/or other means for utilizing aspects of the present disclosures, as may be apparent to those with skill in the art. For example, the network architecture 200 may include means for accessing a user's spending constraints or preferences and for generating offers for adjusted sales of one or more items in a sales inventory, according to aspects of the present disclosure. Example means for accessing the user's spending constraints or preferences could include a receiver coupled to web server 216 or API server 214 and configured to receive information associated with the user's spending constraints via network 204. Example means for generating offers could include a program in application server(s) 218 and/or marketplace system(s) 220 configured to process the spending constraints and generate offers according to principles and concepts consistent with aspects of the present disclosures and described more below. The network architecture 290 may facilitate sales from a retailer's or merchant's perspective. In some cases, the offers generated in response to the accessed spending constraints can be displayed at kiosks or digital signs in a retail store, not shown. In some example embodiments, a networked system 202 may facilitate a network-based marketplace system 220, providing server-side functionality via a network 204 (e.g., the Internet or wide area network (WAN) one or more client devices 219 and 212. FIG. 2 illustrates, for example, a web client 206 (e.g., a browser, such as the Internet Explorer® browser developed by Microsoft®) and a programmatic client 208 executing on respective client devices 210 and 212. The network-based marketplace system 220 may include one or more processors for generating offers for items based on received spending constraints or preferences from a potential customer.

Examples of client devices 210 and 212 may include, but are not limited to, mobile phones, desktop computers, laptops, portable digital assistants (PDAs), smart phones, tablets, ultra books, netbooks, laptops, multi-processor systems, microprocessor-based or programmable consumer electronics, game consoles, set-top boxes (STBs), wearable devices, or any other communication device that a user may utilize to access the networked system 202. Example client devices 210 and 212 may be consistent with the mobile device 100 described in FIG. 1. In some embodiments, the client device 210 may comprise a display module (not shown) configured to display information (e.g., in the form of user interfaces) and images. In further embodiments, the client device 210 may comprise one or more of touch screens, accelerometers, gyroscopes, cameras, microphones, global positioning system (GPS) devices, and so forth. The client devices 210 and 212 may transmit spending constraints or preferences of a user 205 through a wireless network 204, such as through Wifi or Bluetooth®. The networked system 202 may then generate an offer of one or more items in a retailer's inventory in response to the user's constraints or preferences. In some example embodiments, the networked system 202 is a network-based marketplace that responds to requests for product listings, publishes publications comprising item listings of products available on the network-based marketplace, and manages payments for these marketplace transactions. The product listings may include an offered price to purchase products based on the user's constraints or preferences. One or more users 205 may be a person, a machine, or other means of interacting with client devices 210 and 212. In embodiments, the user 205 is not part of the network architecture 200, but may interact with the network architecture 200 via client devices 210 and 212 or another means.

An application program interface (API) server 214 and a web server 216 may be coupled to, and provide programmatic and web interfaces respectively to, one or more application servers 218. The application servers 218 may host one or more marketplace systems 220, which may comprise one or more modules or applications and which may be embodied as hardware, software, firmware, or any combination thereof. The application servers 218 are, in turn, shown to be coupled to one or more database servers 224 that facilitate access to one or more information storage repositories or database(s) 226. In some example embodiments, the databases 226 are storage devices that store information to be posted (e.g., publications or listings, images of products, etc) to the marketplace system(s) 220. The databases 226 may also store digital information about various items in a retailer's inventory, in accordance with example embodiments.

The marketplace system(s) 220 may provide a number of marketplace functions and services to users 205 that access the networked system 202. For example, after receiving or accessing a user's spending constraints or preferences from a receiver associated with networked system 202 and configured to receive information associated with the user's spending constraints via network 204, offers of products in the marketplace system's 220 inventory can be generated based on the user's 205 known constraints or preferences. Example methods for generating offers will be discussed in more detail below. These offers can be displayed in one or more retail stores associated with the marketplace system 220, in locations viewable by the user 205. While the marketplace system(s) 220 is shown in FIG. 2 to form part of the networked system 202, it will be appreciated that, in alternative embodiments, the marketplace system(s) 220 may form part of a payment service that is separate and distinct from the networked system 202.

Further, while the client-server-based network architecture 200 shown in FIG. 2 employs a client-server architecture, the present inventive subject matter is, of course, not limited to such an architecture, and may equally well find application in a distributed, or peer-to-peer, architecture system, for example. The various marketplace system(s) 220 may also be implemented as standalone software programs, which do not necessarily have networking capabilities.

The web client 206 accesses the various marketplace system(s) 220 via the web interface supported by the web server 216. Similarly, the programmatic client 208 accesses the various services and functions provided by the marketplace system(s) 220 via the programmatic interface provided by the API server 214. The programmatic client 208 may, for example, be a seller application (e.g., the Turbo Lister application developed by eBay® Inc.) to enable sellers to author and manage listings on the networked system 202 in an off-line manner, and to perform batch-mode communications between the programmatic client 208 and the networked system 202.

Additionally, a third party application(s) 228, executing on a third party server(s) 230, is shown as having programmatic access to the networked system 202 via the programmatic interface provided by the API server 214. For example, the third party application 228, utilizing information retrieved from the networked system 202, may support one or more features or functions on a website or digital advertising display hosted by the third party. The third party website or display may, for example, provide one or more promotional, marketplace, or payment functions that are supported by the relevant applications of the networked system 202. The third party server 230 may help proliferate offers or advertisements for items owned or controlled by the third party, through advertising means that may be adjusted or modified based on the accessed user 205 constraints or preferences.

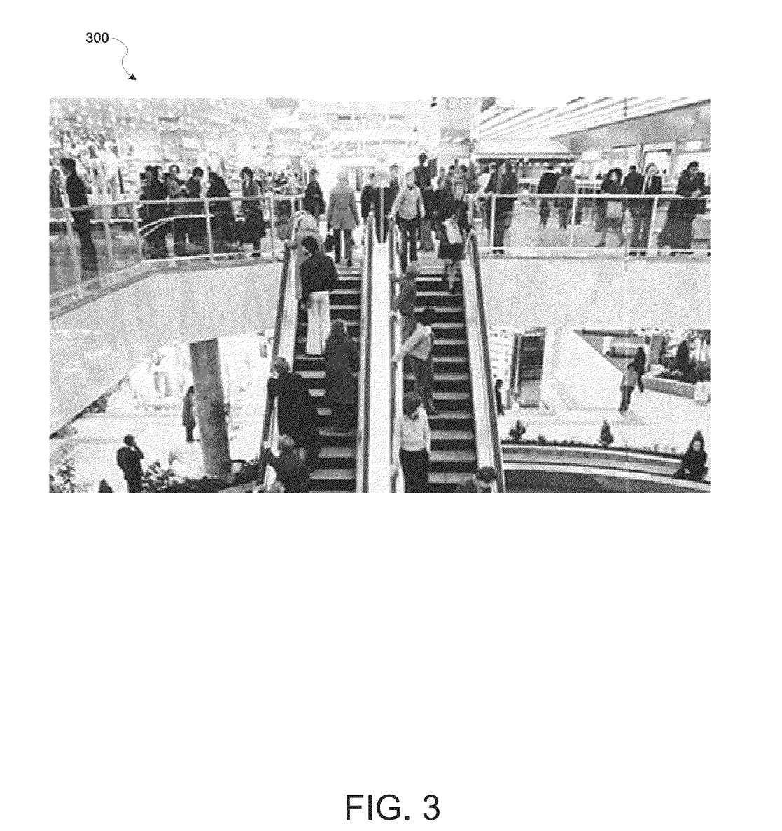

Referring to FIG. 3, an example shopping mall 300 is shown as an appropriate environment for using aspects of the present disclosure. In an example use case of some example embodiments, a shopper may walk around the various stores within mall 300 and may have a specific budget or simply only so much money left in her purse. The shopper may be interested in finding one or more products that fall within her budget or that she can buy with her remaining money. Certainly, the shopper can look for items the conventional way, by browsing through the different aisles in the various stores and looking up prices that may fit her budget. In some cases, sales representatives may approach the shopper and ask if she can be assisted with looking for any item in particular. The shopper may look through various stores, talk with several different sales representatives, and repeat this through a number of iterations until she feels she found the best deal, or decide that none of the stores are offering what she is looking for. In the end, the shopper may have spent a fair amount of time trying to find the best use of her money. If the shopper leaves the mall 300 without having spent any of her money, she may have considered her searching a waste of time, while the retailers may have missed an opportunity to earn the shopper's money through a sale satisfying the shopper's specific spending constraints. In some cases, at least some of the retailers in shopping mall 300 may have been willing to work out a deal with the shopper to earn her money if they knew more information. For example, a retailer may have been willing to adjust some prices for some of the retailer's products in order to fit within the shopper spending constraints, if they only knew what the shopper's spending constraints were. The retailer may prefer making a deal for product at a slightly discounted price than simply let the shopper walk away without spending any of her money. In general, both the shopper and retailer may make different choices towards reaching a mutually agreed-upon sale if more information was known about the shopper's spending constraints or preferences.

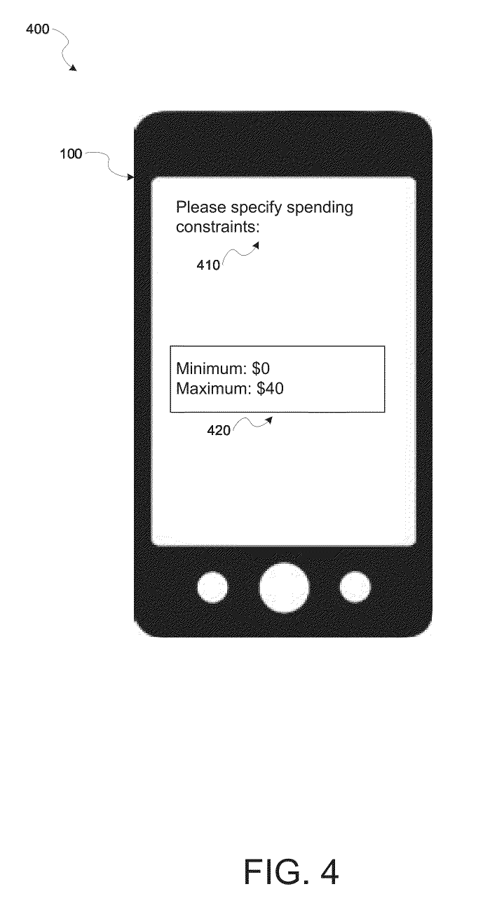

Referring to FIG. 4, illustration 400 shows an example technique for conveying the shopper's spending constraints or preferences in order to facilitate a more efficient consumer transaction, according to some example embodiments. Here, a shopper may have in her possession a mobile device 100, in sonic cases consistent with the mobile device described in FIG. 1. An application on mobile device 100 may prompt the shopper for information regarding any spending constraints, such as the prompt 410. Referring back to the example in FIG. 3, the shopper, for example, may have wanted to spend only $40, or may have had only $40 remaining in her purse. Thus, in response to the prompt 410, the shopper may enter a maximum spending limit of $40 into the application on mobile device 100, as shown in response box 420. In some cases, the shopper may also enter a minimum spending limit, but in this case that amount is zero. In some example embodiments, after the shopper's spending constraints are entered, the application on mobile device 100 can transmit these spending constraints to one or more receivers controlled by various retailers that are near the shopper. The one or more receivers may be coupled to web server 216 or API server 214 in networked system 202, shown in FIG. 2. For example, various retailers may be in control of a corresponding application connected to a receiver for receiving the shopper's constraints transmitted by mobile device 100. In some example embodiments, mobile device 100 can determine when to transmit the shopper's spending constraints based on various sensors or received signal strength of the retailer's receiver, thereby determining that the mobile device 100 is within some physical proximity to the retailer. An example system for receiving the shopper's spending constraints can include the networked system 202 described in FIG. 2.

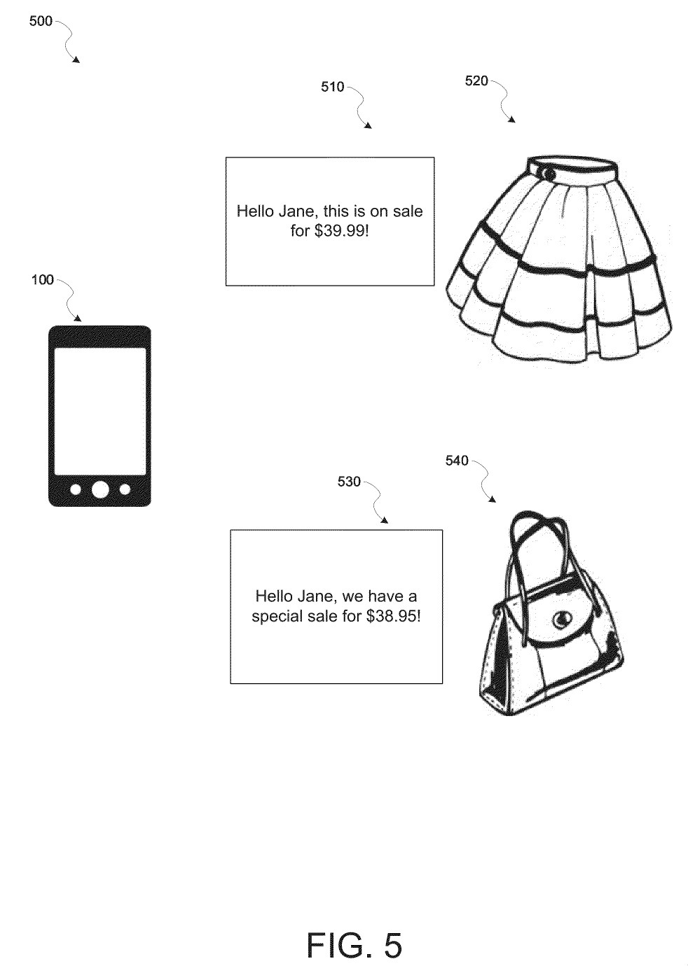

Referring to FIG. 5, illustration 500 shows an example response by the retailer based on the example scenario in FIG. 4. Here, as the shopper walks around mall 300, not shown, while carrying mobile device 100 with specified spending constraints as previously mentioned, retailers around mall 300 may pick up signals of the specified constraints from mobile device 100 and may generate an offer for sale of one or more of their products accordingly. For example, once a retailer knows that the shopper has a spending constraint of not more than $40, the retailer may try to offer the shopper a product the retailer feels is within a price range of $40 and may also tailor an advertisement directed at that particular shopper. Sale sign 510 may be one example ad that may be generated after accessing the spending constraints transmitted from mobile device 100. This example ad states, “Hello Jane, this is on sale for $39.99!” in some example embodiments, mobile device 100 may also transmit additional information, such as the shopper's name or other personalized information at the shopper's choosing, to help facilitate a more personal shopping experience. Addressing the shopper by name or by some other unique identifier may also more effectively draw attention to the retailer's ad and can signal to the shopper which ads may be directly tailored to her. The example sale sign 510 may be a digital kiosk or digital sales tag that may be configured to change at a moment's notice, or at least be programmed with modified text by a sales representative, or a computer processor, according to some example embodiments. The sale sign 510 may be placed next to a product, such as skirt 520, signaling that the skirt 520 is on sale for $39.99, in response to the received spending constraints from the shopper. Originally, the skirt 520 may not have been on sale for $39.99, but because the retailer knew that the shopper has the transmitted spending constraint of $40, the retailer may have determined that a sale of skirt 520 may not be possible with that shopper unless the price of skirt 520 was dropped down to within $40. Furthermore, the retailer may have decided that a sale of skirt 520 at $39.99 is an acceptable price, and thus was willing to discount skirt 520 in an effort to earn a sale from the shopper.

As another example, a second retailer within mall 300 may also receive the spending constraint from mobile device 100 as the shopper nears the second retailer. Using the same or similar techniques as the first retailer, the second retailer may generate an ad on a digital sign 530 in response to the received spending constraint, for example. In this case, digital sign 530 states, “Hello Jane, we have a special sale for $38.95!” Digital sign 530 may be in reference to bag 540. Again, bag 540 may not have been originally on sale for $38.95, but in effort to earn a sale from the shopper, the second retailer may have decided to discount the price slightly to fall within the shopper's spending constraint of $40. Moreover, the second retailer may have concluded that it is acceptable to lower the price of bag 540 to $38.95 in order to earn a sale from the shopper. Furthermore, knowing or perhaps supposing that other retailers may offer products at a price just barely below $40, the second retailer may have decided to drop the price of bag 540 just a little bit lower, e.g., to $38.95.

In other cases, a retailer may choose not to discount a product in order to fit within the transmitted spending constraint, but may instead generate a tailored ad addressed to the shopper of a product already within the spending constraint. In this way, the shopper can more easily see what products are available to her within her spending constraint. As another example, the retailer may utilize the information obtained from the shopper's constraints by configuring prices of inventory the retailer wishes to move more quickly, such as items on sale, items going out of fashion, or items pertinent to a season that is passing. As another example, a program, algorithm, or system controlled by the retailer can be configured to automatically adjust prices or offer items to the shopper based on some predetermined responses or criteria after receiving the shopper's constraints. For example, a program controlled by the retailer may be instructed to find items near the shopper's maximum spending constraint and may automatically discount those items by some predetermined percentage. As another example, a sales representative of the retailer may be authorized to discount prices in response to a received shopper's spending constraint by only a maximum percentage, whereas a store manager may be authorized to offer discounts at a steeper percentage. In yet another example, the retailer may choose to combine multiple items in a packaged bundle for a total price satisfying the shopper's spending constraint. In other cases, the retailer may choose to offer an item that is not on sale but within the shopper's spending constraint, and also include a coupon or rebate, or some other future financial savings with the purchase that might not otherwise be included. In general, it may be apparent to those with skill in the art of many other ways a retailer can offer sales, deals, and/or price adjustments based on information obtained through aspects of the present disclosure, and embodiments are not so limited.

In some example embodiments, additional ways to convey the generated offers to the shopper can be included. For example, a digital display showing prices for items might normally show a default retail price, but may automatically adjust prices if the shopper's mobile device 100 is detected in the vicinity of the digital display. As another example, text messages or visual advertisements could be transmitted back to the device from which the spending constraint originated, with the text messages or visual advertisements including information about one or more sales in response to receiving the spending constraints. The shopper may not be anywhere near that particular store, and thus the targeted text message or advertisement could be a way to motivate the shopper to visit their store. Certainty, other means for conveying offers in response to the received spending constraints may be apparent to those with skill in the art and embodiments are not so limited.

In some example embodiments, additional constraints or preferences can also be specified and transmitted to one or more retailers. For example, a spending history or product history of the shopper may be recorded and stored in a repository associated with mobile device 100, and the spending history or product history of the shopper may also be transmitted to one or more retailers. A retailer may then focus on products related to the shopper's shopping history, and tailor offers for sale of those particular products to the shopper. As another example, the shopper can simply specify what types of items she may be interested in purchasing within the specified spending constraint. The shopper may enter as much or as little information related to her specific preferences as desired, in some example embodiments. For example, the shopper can specify a certain size of clothes, a certain type of clothes, a certain color or colors of items, a certain brand, a certain type of material, a type of food if looking for food, and the like.

In some example embodiments, the application residing on mobile device 100 may transmit additional information about the user to further improve communication of the user's spending preferences. For example, the user's identity, any loyalty account numbers to loyalty or rewards programs, pictures of the user, personal/physical characteristics (e.g. height, weight, build, measurements, etc.), income level, education background, and/or profession, could be entered by the user and transmitted to retailers. In some cases, additional information like these mentioned could provide additional incentives for retailers to earn a sale from the user. For example, even if the user originally specified a spending constraint of $40, knowing that the user is a member of multiple loyalty programs, has a strong educational background, and/or has a strong income level, could incentivize the retailer to earn a sale in hopes of earning repeat business in the future.

In some example embodiments, the type of monetary medium of exchange can vary, including a combination of multiple types of monetary media of exchange. For example, a user may specify a spending constraint in store credit, money in a separate virtual spending account, such as PayPal®, or a certain credit limit. In other contexts, example embodiments can include offers to barter or trade goods, say at a farmer's market, a swap meet, or a bazaar.

In some example embodiments, the constraints of the shopper can be transmitted to one or more retailers in various ways. For example, a quick response (QR) code could be generated, containing information about the shopper's constraints. A kiosk or other receiving device at a mall 300 could be accessed to learn the shopper's constraints via the QR code. The kiosk could be a different example implementation of part of or all of networked system 202. As another example, the shopper could enter her constraints at a kiosk located at an entrance to the mall 390. The kiosk could be connected to many or all retailers within the mall 300 and could be configured to transmit the shopper's constraints to many or all of the retailers at once. As another example, the user's constraints could be encoded into a bar code or QR code by an application on mobile device 100. The codes could be transmitted via short range radio frequency (RE) means, such as near field communication (NFC), Bluetooth LE®, etc., to nearby retailers as the user nears the retailer's store. Offers for sale by the retailers could be adjusted based on receiving the shopper's constraints before she walks near the retailer's store, but the offers could be displayed only when the shopper's mobile device 100 is detected to be near the retailer's store. As yet another example, the mobile device 100 may be configured to send a wide broadcast of the shopper's constraints to multiple retailers in a geographic proximity.

Based on these descriptions, and according to aspects of the present disclosure, one may be able to see that transmitting spending constraints may help both the shopper and the retailer reach a sale that may take less time and is acceptable to both parties. In addition, communicating additional information to the retailers, such as a spending constraint in these examples, can help both the shopper and the retailer find a more efficient sale, in terms of finding the right product at the right price that meets the preferences of both parties. In some cases, a shopper may be able to leverage the transmitted preferences in an effort to obtain even better deals. For example, because the shopper knows that her preferences are transmitted to multiple retailers, the shopper may be able to pit multiple retailers against each other in a sort of bidding war for her money. As another example, the shopper may also feel that the retailer is more open to haggling, given that the retailer adjusted one or more prices tailored to her specifically. In general, haggling may be made easier in this environment, due to more information being given to the retailer and based on the give-and-take nature of aspects of the present disclosure.

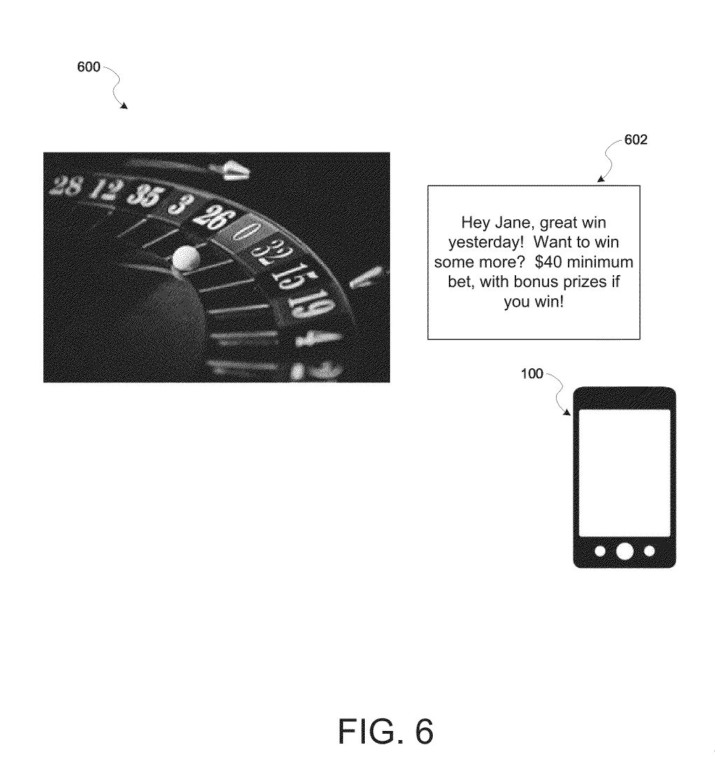

Referring to FIG. 6, aspects of the present disclosure may also be applicable in an entertainment or discretionary spending setting. For example, aspects of the present disclosure can be applicable a casino environment 600, among many other types of entertainment or discretionary spending environments. A patron may enter similar spending constraints as described above, into mobile device 100, shown in FIG. 6. Like before, the patron may carry around mobile device 100, where the mobile device 100 may transmit the patron's spending constraints to various receivers nearby. In this case, the receivers may be directed to specific games on the floor near the receiver. For example, the patron may walk by a receiver next to a game of roulette. The receiver may access the patron's spending constraints via mobile device 100, and may adjust the price to place a bet in response to the received spending constraints. For example, the patron may have made it known that she has $40 left to spend on one or more games. The casino may decide to adjust an offer to play roulette that encourages the patron to spend her last $40 on a single, winner-take-all bet. As a result, a display screen 602 near the roulette wheel may be customized to display, “Hey Jane, great win yesterday! Want to win some more? $40 minimum bet, with bonus prizes if you win!” In this case, information about the patron's gaming history may also be transmitted via mobile device 100, or in other cases, the casino may have kept track of the patron's gaming history based on tracking where mobile device 100 was transmitting to. Accordingly, the message in display screen 602 may also include a reference to previous winnings by the patron and may supply an incentive or suggestion of the chance to win more.

Based on the various example embodiments described in the present disclosure, including descriptions in FIG. 3, 4, 5, or 6, it may be apparent to persons with skill in the art the many variants for utilizing aspects of the present disclosure in a discretionary spending or entertainment environment, and embodiments are not so limited. For example, a gaming casino can offer various other types of incentives or discounts after knowing a patron's spending constraints, such as coupons or vouchers to restaurants, room service, or hotel stays. As another example, during a sporting event with concessions and nearby souvenir shops, a user could transmit a spending constraint of his remaining $50 available for one or more food and souvenir items. A manager of the concessions stand may offer a packaged deal for a total price of $50, in the event that the user may wish to spend all $50 only if a deal or discount was offered. In other cases, a company managing concessions and a souvenir shop could offer a different package including both food and one or more souvenirs.

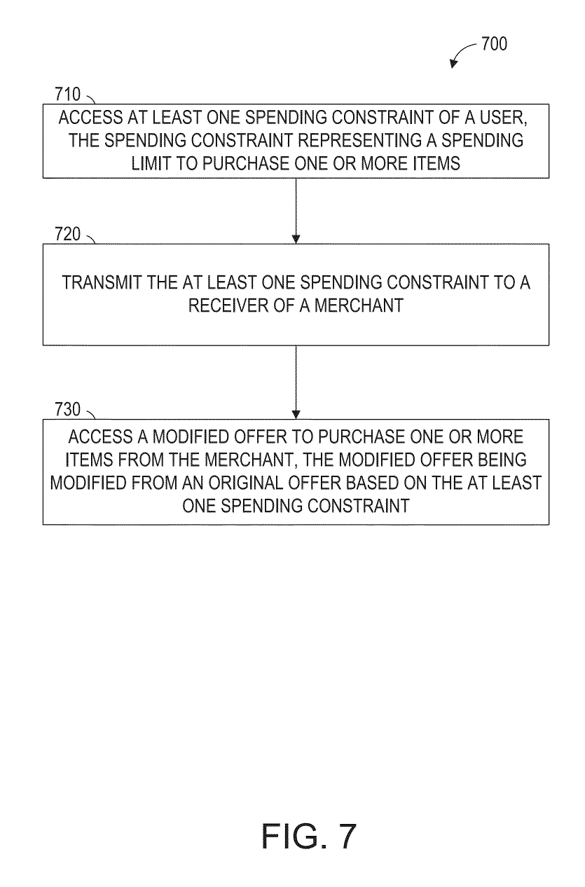

Referring to FIG. 7, the flowchart illustrates an example methodology 700 for conducting consumer transactions using dynamic pricing, according to aspects of the present disclosure. The example methodology may be consistent with the methods described herein, including, for example, the descriptions in FIGS. 3, 4, 5, and 6, and may be directed from the perspective of a mobile device controlled by a user inputting various spending constraints and preferences. At block 710, a mobile device of a user may access at least one spending constraint of the user. The spending constraint may represent a spending limit to purchase one or more items. The spending constraint may be specified by the user in response to a prompt supplied by an application of the mobile device. An example of a mobile device can include the mobile device 100 described in FIG. 1, the client devices 210 and 212 described in FIG. 2, or other mobile devices consistent with the descriptions herein and apparent to those with skill in the art. Examples of spending constraints can include these spending constraints described in any of FIG. 3, 4, 5, or 6. In some example embodiments, additional constraints can be specified by the user and accessed by the mobile device, such as the additional product preferences described in the present disclosure.

At block 720, the mobile device may transmit the at least one spending constraint to a receiver of a merchant. Example methods for transmitting the at least one spending constraint can include the various examples for transmitting a spending constraint described in the present disclosure. Examples of a merchant can include retail stores and malls, restaurants, casinos, or, in general, any entity or establishment engaged in commerce. The receiver of the merchant may be a part of a larger system configured to generate modified offers directed to the user and in response to the received spending constraint. An example of such a system can include the network architecture described in FIG. 2, as well as other networked or non-networked systems consistent with the present disclosure and apparent to those with skill in the art.

At block 730, the mobile device may access a modified offer to purchase one or more items from the merchant. The modified offer may be modified from an original offer and may be based on the at least one spending constraint transmitted to the merchant. The original offer may be a default retail price of the item, and in general may be set at a higher price than the modified offer. Examples of modified offers include the examples of adjusted prices described throughout the present disclosure, including discounted prices and offers for sale of an item combined with coupons or rebates, or items specially packaged in a bundle. In some example embodiments, the modified offer may be directed exclusively to the shopper, due to the shopper's specific spending constraint. In some example embodiments the modified offer may also be based on any additional product preferences similarly transmitted to the merchant by the mobile device. Examples for accessing the modified offer can include the various examples described throughout the present disclosure, including receiving an offer directly on the mobile device or accessing the offer from a display screen within a retail store.

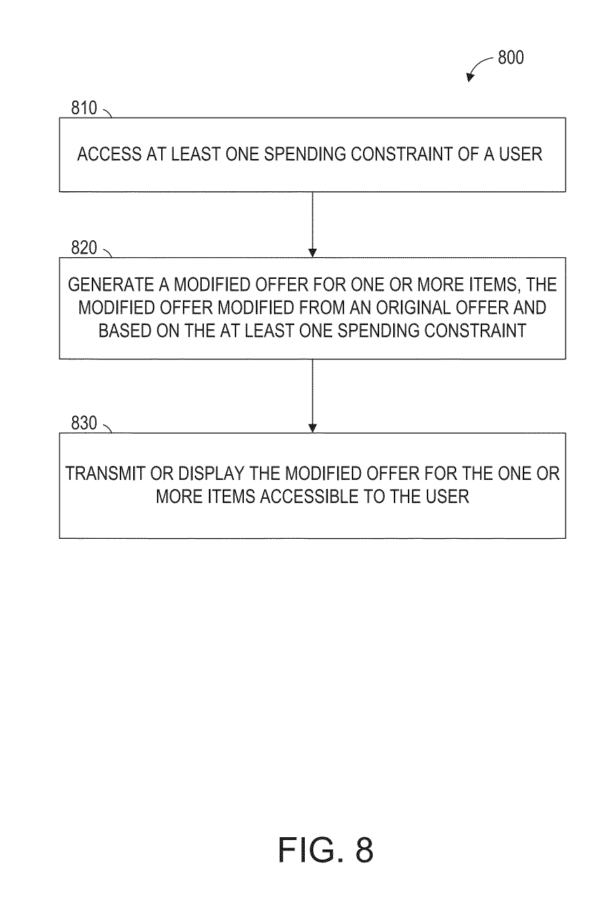

Referring to FIG. 8, the flowchart illustrates another example methodology 800 for conducting consumer transactions using dynamic pricing, according to aspects of the present disclosure. The example methodology may be consistent with the methods described herein, including, for example, the descriptions in FIGS. 3, 4, 5, and 6, and may be directed from the perspective of a retailer or merchant responding to spending constraints specified by a potential customer. At block 810, a system of a merchant may access at least one spending constraint of a user. Examples of spending constraints may be consistent with the spending constraints described in FIG. 7 as well as any of the spending constraints described throughout the present disclosure. The system of the merchant may access the spending constraint through a receiver, with the spending constraint being transmitted by a mobile device controlled by the user.

At block 820, the system of the merchant may generate a modified offer for one or more items for sale by the merchant. The modified offer may be modified from an original offer of the item and may be based on the at least one spending constraint. Examples for generating the offer may include any of the examples described herein, as well as those that may be apparent to those with skill in the art. For example, the system of the merchant could be consistent with networked system 202, and marketplace system 220 of the merchant system could include one or more programs configured to access a user's spending constraints and generate an offer tailored to the user, based on those spending constraints and concepts consistent with any of the descriptions in FIGS. 3, 4, 5, 6, and/or 7.

At block 830, the system of the merchant may transmit or display the modified offer for the one or more items accessible to the user. Example means for transmitting the offer to the user can include sending the offer via a text message to the mobile device of the user, or sending a visual advertisement to the mobile device of the user. Example means for displaying the modified offer may include displaying the offer in a display screen in a retail store of the merchant, near the one or more items being offered, as well as any other examples described herein or apparent to those with skill in the art. The example display screens could include the display screen on client device(s) 210 and/or 212, or separately a display screen at a retail store in mall 300.

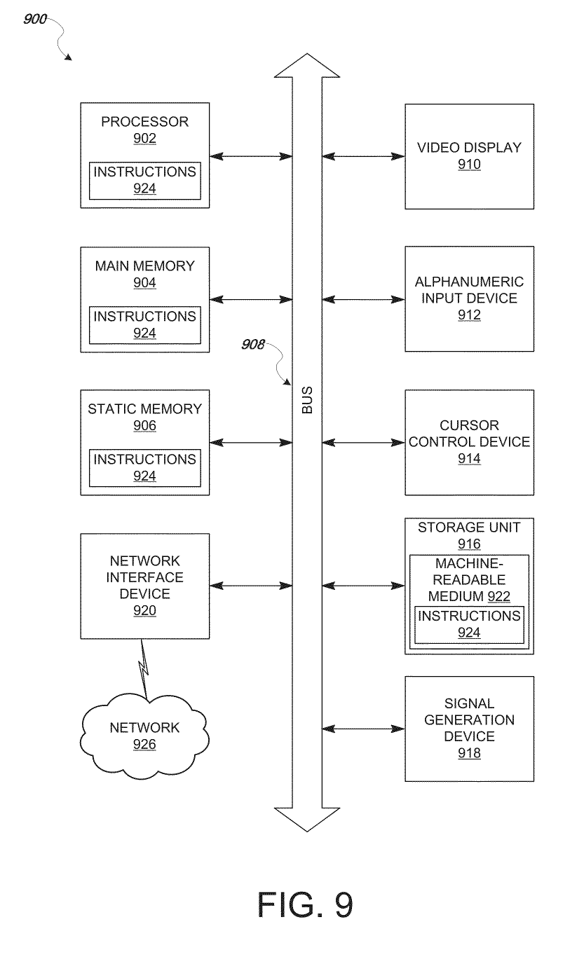

Referring to FIG. 9, the block diagram illustrates components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may include hardware, software, or combinations thereof, and may, as example, be a server computer, a client computer, a personal computer (PC), a, tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine 900 is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPV), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a video display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, a signal generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein, including, for example, any of the descriptions of FIGS. 1, 2, 3, 4, 5, 6, 7, and/or 8. The instructions 924 may also reside, completely or at least partially, within the main memory 904, within the processor 902 (e.g., within the processor's cache memory), or both, before or during execution thereof by the machine 900. The instructions 924 may also reside in the static memory 906.

Accordingly, the main memory 904 and the processor 902 may be considered machine-readable media (e.g., tangible and non-transitory machine-readable media). The instructions 924 may be transmitted or received over a network 926 via the network interface device 920. For example, the network interface device 920 may communicate the instructions 924 using any one or more transfer protocols (e.g., Hypertext Transfer Protocol (HTTP)). The machine 900 may also represent example means for performing any of the functions described herein, including the processes described in FIGS. 1, 2, 3, 4, 5, 6, 7 and/or 8.

In some example embodiments, the machine 900 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions 924. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

1. A computer implemented method comprising:

accessing, at a mobile device of a user, at least one spending constraint of the user, the spending constraint representing a spending limit to purchase one or more items;
transmitting the at least one spending constraint to a receiver of a merchant; and accessing a modified offer to purchase one or more items from the merchant, the modified offer for the one or more items being modified from an original offer for the one or more items based on the at least one spending constraint transmitted to the merchant.

2. The method of description 1, wherein the modified offer for the one or more items is offered exclusively to the user and in response to the at least one spending constraint transmitted to the merchant.

3. The method of description 1, further comprising accessing, at the mobile device, at least one product preference of the user, the at least one product preference representing at least one preference to purchase one item over another item.

4. The method of description 3, further comprising:

transmitting the at least one product preference to the receiver of the merchant; and wherein the modified offer to purchase one or more items from the merchant is further modified based on the least one product preference.

5. The method of description 4, wherein the at least one product preference includes a purchase history of the user; and

wherein the modified offer to purchase one or more items from the merchant is further modified based on the purchase history of the user.

6. The method of description 1, wherein transmitting the at least one spending constraint to the receiver of the merchant comprises transmitting the at least one spending constraint to a third party kiosk, wherein the third party kiosk is configured to transmit the at least one spending constraint to the receiver of the merchant.

7. The method of description 1, wherein the spending constraint includes a store credit limit, a virtual money account limit, or a credit card limit.

8. An apparatus comprising an input interface, an output interface, and at least one processor configured to perform any of the descriptions in descriptions 1 through 7.

9. A computer-readable medium embodying instructions that, when executed by a processor, perform operations comprising any of the descriptions in descriptions 1 through 7.

10. An apparatus comprising means for performing any of the descriptions in descriptions 1 through 7.

What is claimed is:

1. A system comprising:
a memory; and
a processor coupled to the memory and configured to:
access at least one spending constraint of a user, the spending constraint representing a spending limit to purchase one or more items;
transmit the at least one spending constraint to a receiver of a merchant; and
access a modified offer to purchase one or more items from the merchant, the modified offer for the one or more items being modified from an original offer for the one or more items based on the at least one spending constraint transmitted to the merchant.

2. The system of claim 1, wherein the modified offer for the one or more items is offered exclusively to the user and in response to the at least one spending constraint transmitted to the merchant.

3. The system of claim 1, wherein the processor is further configured to access at least one product preference of the user, the at least one product preference representing at least one preference to purchase one item over another item.

4. The system of claim 3, wherein the processor is further configured to:
transmit the at least one product preference to the receiver of the merchant; and
wherein the modified offer to purchase one or more items from the merchant is further modified based on the least one product preference.

5. The system of claim 4, wherein the at least one product preference includes a purchase history of the user; and
wherein the modified offer to purchase one or more items from the merchant is further modified based on the purchase history of the user.

6. The system of claim 1, wherein transmitting the at least one spending constraint to the receiver of the merchant comprises transmitting the at least one spending constraint to a third party kiosk, wherein the third party kiosk is configured to transmit the at least one spending constraint to the receiver of the merchant.

7. The system of claim 1, wherein the spending constraint includes a store credit limit, a virtual money account limit, or a credit card limit.

8. A computer implemented method comprising:
accessing, at a mobile device of a user, at least one spending constraint of the user, the spending constraint representing a spending limit to purchase one or more items;
transmitting the at least one spending constraint to a receiver of a merchant; and
accessing a modified offer to purchase one or more items from the merchant, the modified offer for the one or more items being modified from an original offer for the one or more items based on the at least one spending constraint transmitted to the merchant.

9. The method of claim 8, wherein the modified offer for the one or more items is offered exclusively to the user and in response to the at least one spending constraint transmitted to the merchant.

10. The method of claim 8, further comprising accessing, at the mobile device, at least one product preference of the user, the at least one product preference representing at least one preference to purchase one item over another item.

11. The method of claim 10, further comprising:
transmitting the at least one product preference to the receiver of the merchant; and
wherein the modified offer to purchase one or more items from the merchant is further modified based on the least one product preference.

12. The method of claim 11, wherein the at least one product includes a purchase history of the user; and
wherein the modified offer to purchase one or more items from the merchant is further modified based on the purchase history of the user.

13. The method of claim 8, wherein transmitting the at least one spending constraint to the receiver of the merchant comprises transmitting the at least one spending constraint to a third party kiosk, wherein the third party kiosk is configured to transmit the at least one spending constraint to the receiver of the merchant.

14. The method of claim 8, wherein the spending constraint includes a store credit limit, a virtual money account limit, or a credit card limit.

15. A computer-readable medium embodying instructions that, when executed by a processor perform operations comprising:
accessing at least one spending constraint of a user, the spending constraint representing a spending limit to purchase one or more items;
transmitting the at least one spending constraint to a receiver of a merchant; and
accessing a modified offer to purchase one or more items from the merchant, the modified offer for the one or more items being modified from an original offer for the one or more items based on the at least one spending constraint transmitted to the merchant.

16. The computer-readable medium of claim 15, wherein the modified offer for the one or more items is offered exclusively to the user and in response to the at least one spending constraint transmitted to the merchant.

17. The computer-readable medium of claim 15, wherein the operations further include accessing at least one product preference of the user, the at least one product preference representing at least one preference to purchase one item over another item.

18. The computer-readable medium of claim 17, wherein the operations further include:
transmitting the at least one product preference to the receiver of the merchant; and
wherein the modified offer to purchase one or more items from the merchant is further modified based on the least one product preference.

19. The computer-readable medium of claim 18, wherein the at least one product preference includes a purchase history of the user; and
wherein the modified offer to purchase one or more items from the merchant is further modified based on the purchase history of the user.

20. The computer-readable medium of claim 15, wherein transmitting the at least one spending constraint to the receiver of the merchant comprises transmitting the at least one spending constraint to a third party kiosk, wherein the third party kiosk is configured to transmit the at least one spending constraint to the receiver of the merchant.
